(19) United States
(12) Patent Application Publication
(10) Pub. No.: US 2017/0225139 A1
(43) Pub. Date: Aug. 10, 2017

(54) PHOTOCATALYTIC REACTOR STATOR AND METHOD OF USE

(71) Applicant: CATALYSYSTEMS LIMITED, Middlesbrough, Yorkshire (GB)

(72) Inventor: Irene ALLCROFT, Middlesbrough (GB)

(21) Appl. No.: 15/501,672

(22) PCT Filed: Jul. 29, 2015
(86) PCT No.: PCT/GB2015/052189

§ 371 Date: Feb. 3, 2017

(30) Foreign Application Priority Data
Aug. 4, 2014 (GB) 1413806.9

(51) Int. Cl. B01J 8/42; B01J 8/20

(52) U.S. Cl. CPC B01J 8/42; B01J 8/20; B01J 2208/00867

(57) ABSTRACT

An improved photocatalytic reactor stator having a first surface and an opposing second surface, and at least one channel extending between the first surface and the second surface to allow fluid flow through the stator. The at least one channel may be configured to redirect the fluid flow in a direction substantially parallel to the first and/or second surface. This improved photocatalytic reactor stator improves the performance of a photocatalytic reactor by increasing the mobility of the photocatalyst and thereby increasing the surface area of the catalyst that is exposed to the reactant and the UV light source.

The present invention relates to photocatalytic reactors which use a bed of particulate or granular photocatalyst bodies for the treatment of a fluid, and in particular to an improved stator for use in such reactors. In an embodiment of the invention, there is provided a stator which improves the movement and hence efficacy of the photocatalyst bodies in a photocatalytic reactor. Aspects of the invention include a photocatalytic reactor including such a stator and a method of use.

### BACKGROUND TO THE INVENTION

The rate of a catalytic reaction between a solid phase catalyst and liquid phase reactant depends on, amongst other things, the exposed surface area of the catalyst and the efficiency of diffusion of molecules of the reactant to and from the surface of the catalyst.

Catalytic reactors are engineered to maximise the yield of product obtained by the chemical reactions for which they are designed. A catalytic reactor typically has a reaction chamber containing a catalyst and the reactant. The rate of a catalytic reaction may be limited by mass transfer and therefore by the number of reactant molecules brought into contact with an active site of the catalyst. The volume of the reactor, temperature and mixing of reactants are amongst many parameters that are considered when designing a catalytic reactor, as well as the distribution of the catalyst and the interaction between the reactant and an active site of the catalyst.

Mass transfer is the movement of mass from high concentration to low concentration. In a catalysis process it refers more specifically to the diffusion of reactant molecules to and from an active site of the catalyst. The rate-limiting effects of mass transfer become particularly prevalent when the concentration of the reactant is low, for example when the concentration of reactant is most conveniently measured in parts-per-billion (ppb). The concentrations of, for example, industrial and pharmaceutical residues, herbicides and pesticides are commonly considered a hazard at concentrations in the ppb range. Mass transfer is therefore a major limiting factor in the industrial-scale treatment of water, for example by Advanced Oxidation Processes (AOP).

The Applicant's earlier International Publication Number WO2011/114164, FIG. 1A of which is reproduced herein as FIG. 1, discloses a photocatalytic reactor 10 which comprises a flow-through reaction chamber 12. Inside the reaction chamber 12 there is provided an ultraviolet source 16, mounted longitudinally and centrally in the reaction chamber 12. Stators 18 surround the ultraviolet source 16 and are spatially separated at regular intervals along the longitudinal axis of reaction chamber 12. Each stator 18 provides a bearing surface on which a layer of photocatalyst particles is disposed, and has blades 28 and slots 30 that are configured to induce turbulent flow in the liquid, such that the liquid leaves the stator 18 with a circular or helical flow pattern. The arrangement and spacing of the stators 18 and ultraviolet source 16 is chosen to provide even and complete illumination of the layer of photocatalyst particles disposed on each stator 18.

Notwithstanding the improved efficiencies which the Applicant's above-described photocatalytic reactor provides, it is an object of at least one aspect of the present invention to provide a stator that is capable of further improving the performance of a photocatalytic reactor in which it is deployed.

Further aims and objects of the invention will become apparent from reading the following description.

### SUMMARY OF THE INVENTION

According to a first aspect of the invention, there is provided an improved photocatalytic reactor stator, the improved stator comprising a first surface and an opposing second surface, and at least one channel extending between the first surface and the second surface to allow fluid flow through the stator, wherein the at least one channel may be configured to redirect the fluid flow in a direction substantially parallel to the first and/or second surface.

The redirection of fluid flow may act to move and/or lift photocatalyst particles across the first and/or second surface of the stator.

The above invention may facilitate improved photocatalytic performance of a reactor by increasing the mobility of the catalyst and thereby increasing the surface area of the catalyst that is exposed to the reactant and the UV light source, as applicable.

By redirecting the fluid flow in a direction substantially parallel to the first or second surface the photocatalyst may be agitated, moved and/or lifted around or across the stator surface which may improve the diffusion of reactant molecules to and from an active site of the catalyst and may increase mass transfer.

The stator may be configured to create a vortex in the fluid flow. The vortex may facilitate the agitation, movement and/or lifting of the catalyst around or across the stator surface.

Preferably the first surface and second surface are-substantially planar surfaces.

The profile shape of the at least one channel as it extends between the first surface and the second surface may comprise any suitably shaped profile which allows fluid to exit the at least one channel in a direction substantially parallel to the first or second surface. Preferably the at least one channel has at least a partially curved shaped profile. More preferably the at least one channel has a generally inverted L-shaped profile or an inverted J-shaped profile.

Preferably the at least one channel may comprise any suitably shaped profile which allows fluid to enter and exit the at least one channel in a direction substantially parallel to the first or second surface. Preferably the at least one channel has a generally S-shaped profile.

In one embodiment the stator comprises a plurality of channels configured to redirect the fluid flow in a direction substantially parallel to the first or second surface. The area between one channel and a neighbouring channel may define a section or sector of the stator surface.

The redirected fluid flow in a direction substantially parallel to the first or second surface may allow fluidised photocatalyst particles to move, lift and/or roll from one section or sector to a neighbouring section or sector in a sequential manner.

The first or second surface may comprise at least one hood structure. The hood may be configured to prevent photocatalyst particles entering the at least one channel via the channel outlet. The hood may be further configured to redirect the fluid flow in a direction substantially parallel to the first or second surface.

Preferably, the hood is located at or around the channel outlet. Alternatively the hood may be located at a position displaced from the channel outlet.

The hood may extend from the first or second surface. The area between one hood and a neighbouring hood may define a section or sector of the stator surface. The outer surface of the hood may be configured to be substantially streamlined and allow fluidised or suspended photocatalyst particles to flow across the outer surface of the hood and across the channel outlet on the surface of the stator into the neighbouring section or sector. The hood may be configured to move, lift and/or roll the photocatalyst particles as the fluidised photocatalyst particles flow across the outer surface of the hood.

The stator may be configured to create a vortex in the fluid flow. The vortex may facilitate the movement of the catalyst around or across the stator surface and the hood may be configured to lift and/or roll the photocatalyst particles as the fluidised photocatalyst particles flow across the outer surface of the hood.

The improved stator may comprise at least one channel comprising a linear profile as it extends between the first surface and the second surface, with at least one hood at the channel outlet to redirect the fluid flow in a direction substantially parallel to the first or second surface.

Preferably, the at least one channel has an inlet on the first surface and an outlet on the second surface. The channel inlet may take the form of a groove or slot on or across the first surface. The channel outlet may take the form of a groove or slot on or across the second surface. The shape of the groove or slot may comprise any suitably curved and/or linear shape. In one embodiment a plurality of channel inlets and/or outlets may be arranged on the first and/or second surface substantially symmetrically around the stator to try and prevent the photocatalyst particles being moved and/or deposited unevenly.

The dimensions of the channel outlet and channel inlet may be configured to increase turbulence and/or transport of the mobile photocatalyst particles across and/or around the stator surface.

The channel outlet may have a cross-sectional area which is equal to the cross-sectional area of the channel inlet.

The channel outlet may have a cross-sectional area which is less than that of the corresponding inlet. This reduction in cross-section may create a jetting effect which provides a relative increase in fluid velocity near the outlet. This jetting effect may increase the movement of the catalyst and may increase turbulence which may cause further movement of the photocatalyst particles.

In one embodiment the channel outlets are arranged on the surface of the stator such that when a photocatalyst particle has moved away from the jetting effect created by a first channel outlet it may fall or sink towards the stator whereupon it may be exposed to a subsequent fluid jet effect of a neighbouring channel outlet. This non-continuous sequential movement of catalyst particles may further increase the surface area of the catalyst exposed to the reactant and the light source and may increase mass transfer. The non-continuous sequential movement of catalyst particles around and across the surface of the stator may be achieved in any other way—accordingly, the stator is preferably configured to effect such a non-continuous sequential movement of catalyst particles when in use.

Preferably, the channel outlet may be sized to prevent the ingress of photocatalyst. In one embodiment, the size of the channel outlet may be such that it may permit ingress of the photocatalyst particles and a hood located at or around the channel outlet may be configured to prevent the ingress of photocatalyst in the channel outlet.

Preferably, the improved stator may comprise at least one aperture for a light source. Alternatively, the light source may be one or more discrete light source located in and/or around the reactor. The stator may be transparent to the light from the light source to permit illumination of the photocatalyst material from below.

Preferably the stator may extend transversely across the longitudinal axis of the reaction chamber. The stator may comprise a disc structure having any shape suitable to extend transversely across the longitudinal axis of the reaction chamber. Preferably the stator comprises a substantially circular disc.

Seals may be provided around the inner and outer perimeters of the stator to prevent fluid travelling through the reactor from bypassing the stator.

Preferably the stator has a plurality of channels extending between the first surface and the second surface to allow fluid flow through the stator. The stator may comprise any number of channels but may preferably comprise a minimum of two channels and a maximum of one hundred channels. Preferably the stator may comprise a minimum of five channels and a maximum of forty channels. More preferably, the stator has twenty channels.

In addition to the at least one channel redirecting the fluid flow in a direction substantially parallel to the first and/or second surface, the at least one channel may be configured to introduce a circular, rotational or helical flow component to the fluid. The stator may therefore comprise at least one channel configured to direct the fluid in a clockwise or an anti-clockwise direction. Alternatively the stator may comprise a plurality of channels, wherein at least one of the channels is configured to direct flow in a clockwise direction and wherein at least one of the remainder of the channels is configured to direct flow in an anticlockwise direction. Such an arrangement may produce a high degree of turbulence.

According to a second aspect of the invention there is provided a photocatalytic reactor comprising a reaction chamber having a fluid inlet and a fluid outlet displaced in a longitudinal direction of the reaction chamber, at least one stator according to the first aspect located between the fluid inlet and the fluid outlet, and a plurality of mobile photocatalyst particles disposed on the at least one stator.

Preferably the photocatalyst particles are granular, powders, agglomerates or pellets. The photocatalyst particles may be formed by compaction, moulding, extrusion, milling, agglomeration or granulation. The mobile photocatalyst particles may be disposed as a layer on the at least one stator. The at least one stator may be a support surface for a layer of mobile photocatalyst particles.

The photocatalyst particles may comprise a semi-conductor catalyst which include but are not limited to titanium dioxide, a metal doped titanium dioxide, zinc oxide, iron oxide, cadmium sulphide and zinc sulphide.

Alternatively, the photocatalyst particles may comprise a catalyst support material core coated with photocatalyst material.

The photocatalyst particles may adopt any suitable shape. Preferably, the photocatalyst particles may comprise a substantially cylindrical shape. More preferably the photocatalyst particles may comprise a substantially spherical shape.

The photocatalyst particles may have a minimum diameter of greater than approximately 0.1 mm and a maximum diameter of less than approximately 5 mm.

The size and density of the photocatalyst particles may be chosen such that they are negatively buoyant in the fluid in the apparatus, and may therefore rest on the surface of the stator. Alternatively, the photocatalyst particles may be neutrally or positively buoyant and/or otherwise configured to be lifted or moved when exposed to a jet of fluid from the at least one channel in the stator.

The fluid is a reactant fluid, and is preferably a liquid to be treated by the photocatalytic reaction.

The reaction chamber may comprise a plurality of spatially separated cells or sub-chambers, and each cell or sub-chamber may comprise a stator. The cells or sub-chambers may be formed from a plurality of stators. Preferably, each stator may support a layer of mobile photocatalyst particles. The plurality of stators may be displaced from one another in the reaction chamber along the longitudinal direction of the chamber, such that the fluid passes sequentially through the sub-chambers. Preferably, each of the stators is a stator according to the first aspect.

The reaction chamber may comprise an aeration system which may be configured to deliver gas bubbles to the reaction chamber. The gas bubbles may comprise oxygen, ozone and/or air. The reaction chamber may comprise a bleed valve for the removal of gas and/or gas bubbles. The aeration system may be located at the bottom of the reaction chamber and may be configured to provide an even airflow through the reactor chamber. The aeration may assist the sparing of catalyst surface and prevent permanent binding of chemicals to the active site of the catalyst.

The reactor inlet may be configured to induce flow swirls and/or a vortex within the reactor. The reaction chamber may comprise nozzles configured to induce a vortex in the inlet fluid flow. The presence of flow swirls or vortices within the inlet fluid flow may enhance and/or assist the effects of a vortex implemented by the stator.

Embodiments of the second aspect of the invention may comprise features corresponding to any of the essential, preferred or optional features of any other aspect of the invention or vice versa.

According to a third aspect of the invention there is provided a method of carrying out a photocatalytic reaction, the method comprising:
providing a photocatalytic reactor comprising at least one stator according to the first aspect;
providing a layer of mobile photocatalyst particles disposed on at least one surface of the stator;
providing a flow of fluid through the stator; and
redirecting the fluid flow in a direction substantially parallel to the at least one surface of the stator.

The method may comprise the step of redirecting the fluid flow to agitate, move and/or lift the mobile photocatalyst particles.

The method may comprise adjusting the fluid flow through the reactor and/or adjusting the fluid flow through the stator to optimise the movement of the mobile photocatalyst particles across or around the at least one surface of the stator.

The method may comprise adjusting the fluid flow through the reactor and/or adjusting the fluid flow through the stator until the fluidisation generated by the fluid flow is greater than the fluidisation value of the photocatalyst particles.

The method may further comprise the step of providing light within a predetermined range of wavelengths to the mobile photocatalyst particles. The provided light may be orientated along a longitudinal direction in the reactor. The provided light may additionally or alternatively be provided by one or more discrete light sources located in or around the reactor.

Embodiments of the third aspect of the invention may comprise features corresponding to any of the essential, preferred or optional features of any other aspect of the invention or vice versa.

According to a fourth aspect of the invention there is provided a method of carrying out a photocatalytic reaction, the method comprising:
providing a photocatalytic reactor comprising at least one stator according to the first aspect;
providing a layer of mobile photocatalyst particles disposed on at least one surface of the stator;
providing a flow of fluid through the stator;
redirecting the fluid flow to sequentially move the mobile photocatalyst particles around the at least one surface of the stator in a non-continuous path.

The method may comprise adjusting the fluid flow through the reactor and/or adjusting the fluid flow through the stator to optimise the sequential and non-continuous movement of the mobile photocatalyst particles across or around the at least one surface of the stator.

The method may comprise adjusting the fluid flow through the reactor and/or adjusting the fluid flow through the stator until the fluidisation generated by the fluid flow is greater than the fluidisation value for the photocatalyst particles.

Embodiments of the fourth aspect of the invention may comprise features corresponding to any of the essential, preferred or optional features of any other aspect of the invention or vice versa.

### BRIEF DESCRIPTION OF THE DRAWINGS

Aspects and advantages of the present invention will become apparent upon reading the following detailed description and upon reference to the following drawings (like reference numerals referring to like features) in which:

FIG. 1 presents a photocatalytic reactor in accordance with the prior art shown in perspective view;

FIG. 2A presents a photocatalytic reactor stator in accordance with the present invention shown in perspective view;

FIG. 2B presents an enlarged view of portion B of FIG. 2A, illustrating in profile a single channel through the photocatalytic reactor stator; and

FIG. 2C presents an enlarged view of portion C of FIG. 2A, illustrating in cross-section a single channel through the photocatalytic reactor stator.

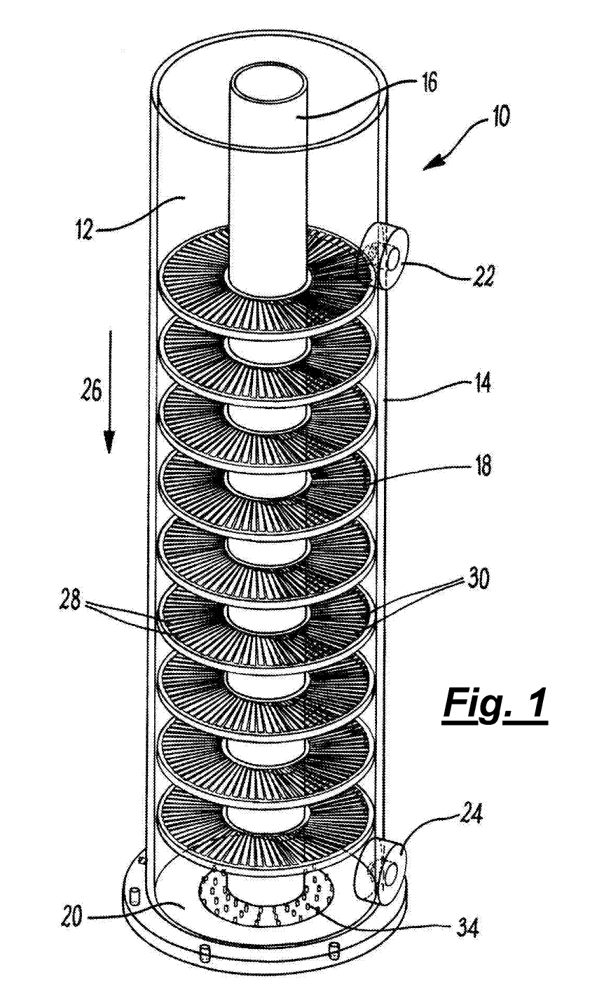

### DETAILED DESCRIPTION OF PREFERRED EMBODIMENTS

As discussed in the background to the invention above, it is an object of at least one aspect of the present invention to provide a stator that is capable of further improving the performance of a photocatalytic reactor including such a stator. It is recognised that the rate of reaction between a solid phase catalyst and a liquid phase reactant depends on the exposed surface area of the catalyst and the efficiency of diffusion of molecules of the reactant to and from the surface of the catalyst.

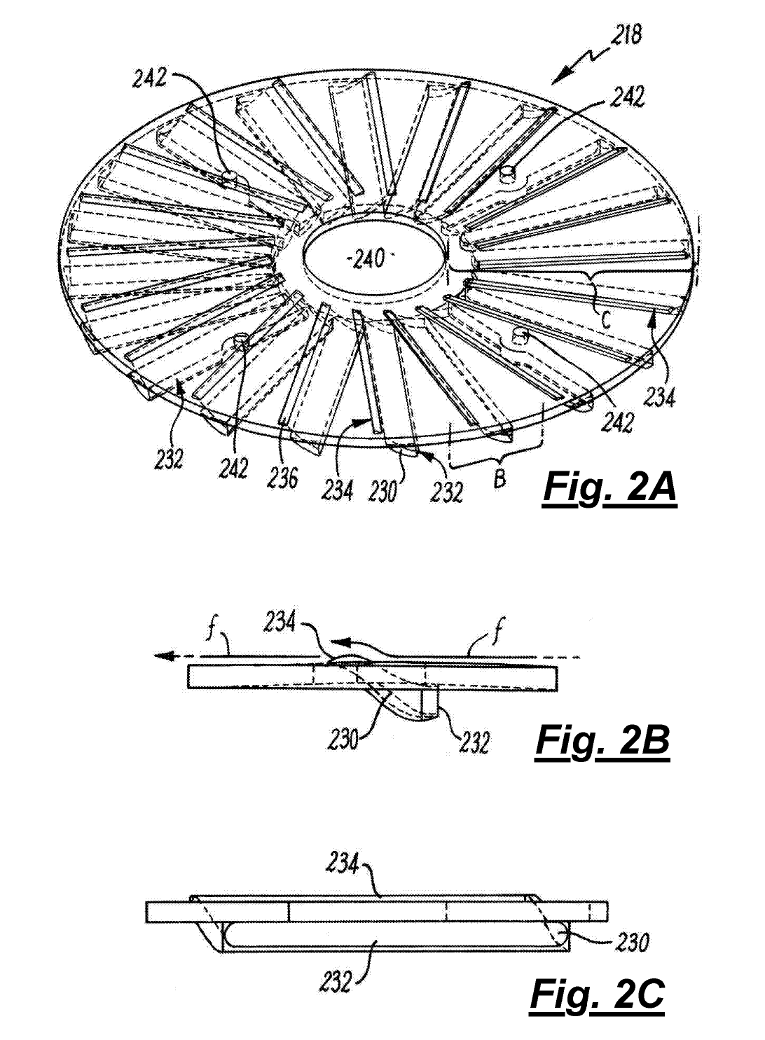

An embodiment of the present invention is illustrated in FIG. 2A and provides a number of advantages over stators employed in prior art reactors, specifically by increasing the effective exposed surface area of photocatalyst particles disposed on the stator and by increasing the interaction of the photocatalyst particles with a fluid to be treated and with a UV light source when in use.

An improved photocatalytic reactor stator 218 can be seen to comprise a circular disc with a number of channels 230, in this case twenty, which permit fluid communication through the stator 218. Central aperture 240 extends through the stator 218 but is provided to accommodate a central Ultraviolet (UV) light source (not shown) which may extend along the full length of a reactor in which the stator 218 is employed. Accordingly, there is no fluid communication through this aperture 240. Likewise, apertures 242 do not provide fluid communication therethrough, but are provided to help locate and/or retain the stator 218 in a reactor.

Alternatively the stator 218 may not have a central aperture 240 and instead at least one ultraviolet light source may be provided which may be positioned at various locations in and/or around the reactor.

Fluid communication through the stator 218 is therefore restricted to the flow paths provided by the channels 230. Preferably, when located in a reactor, seals (not shown) may be provided around the inner and outer perimeters, where applicable, to prevent fluid travelling through the reactor from bypassing the stator 218.

The channels 230 can be seen to be generally s-shaped in profile, such that fluid enters the channels 230 (via inlet 232) in a substantially horizontal direction and, more importantly, exits the channels 230 (via outlet 234) in a substantially horizontal direction. As such, fluid passing through the stator 218 is, at least initially, directed across the surface of the stator 218. Furthermore, the fluid is directed towards a neighbouring channel 230.

In use, a layer of mobile photocatalyst particles (not shown) will be disposed on the upper surface of the stator 218. The fluid flow across the surface of the stator 218 from the outlets 234 resulting from the configuration of the channels 230 serves to entrain photocatalyst particles in the fluid flow where they can interact with contaminants as well as being moved across the surface. Furthermore, by at least initially restricting the fluid flow to a direction across the surface of the stator 218, the risk of photocatalyst particles being carried or propelled upwards to a subsequent stator (a complete reactor may include several such stators) where they may become trapped in the inlets of said stator or enter the corresponding channels is significantly reduced. Additional apparatus or components to prevent clogging is therefore not required.

Movement of the photocatalyst particles across the surface of the stator 218 may improve mass transfer of contaminants from the fluid to be treated to the surface of the photocatalyst particles. An additional benefit may be that the movement of the photocatalyst particles across the surface of the stator 218 will have a scrubbing or cleaning effect on the stator 218. Similarly, the resulting collisions between photocatalyst particles will have a scrubbing or cleaning effect on the photocatalyst particles themselves.

The outlet 234 of each channel 230 can be seen to comprise a hood 236 which may serve a number of purposes. When not in use, i.e. when there is no fluid flow through the stator 230, the hood 236 prevents photocatalyst particles from settling in the outlet or even falling through the channel. When in use, as well as serving this purpose the hood 236 provides a disturbance in the fluid flow path as indicated by arrow fin FIG. 2B—which further agitates the photocatalyst particles, for example causing them to lift and roll or tumble which increases exposure of the photocatalyst material to contaminants and also to the relevant UV light source.

Another benefit of directing fluid flow across the surface of the stator 218 is that higher fluid velocities can be accommodated or tolerated without detrimental effects on a reactor system within which the stator 218 is deployed. As noted above, there is a much reduced risk of the photocatalyst particles interfering with the stator above. Furthermore, collisions between photocatalyst particles and/or other frictional interactions (for example with the surface of the stator 218 itself or even the relatively lower velocity fluid immediately above) may serve to reduce fluid and/or photocatalyst particle velocity significantly within a short vertical distance of the stator 218.

To increase the initial fluid velocity from the outlet 234, which may increase turbulence and/or transport of photocatalyst particles across the stator 218, the outlet 234 may have a cross-sectional area which is less than that of the corresponding inlet 232. This reduction in cross-section creates a jetting effect which provides a relative increase in fluid velocity near the outlet 234. This jetting effect increases the movement of the catalyst and increases turbulence which may cause further rotational movement of the photocatalyst particles.

The dimensions of the outlet 234 and inlet 232 may be configured to create a jetting effect which results in the photocatalyst particles lifting and moving across or around the stator 218 surface in a non-continuous sequential path. When the photocatalyst particle has moved out of the jet of fluid it falls towards the stator 218 where it may be exposed to a fluid jet of a neighbouring channel 230. This sequential movement of catalyst particles further increases the surface area of the catalyst exposed to the reactant and the light source and increases mass transfer.

The invention provides an improved photocatalytic reactor stator. The improved stator comprises a first surface and an opposing second surface, and at least one channel extending between the first surface and the second surface to allow fluid flow through the stator. The at least one channel may be configured to redirect the fluid flow in a direction substantially parallel to the first and/or second surface.

The improved photocatalytic reactor stator improves the performance of a photocatalytic reactor by increasing the mobility of the photocatalyst and thereby increasing the surface area of the catalyst that is exposed to the reactant and the UV light source.

Another benefit of the improved stator is that it may improve the performance of a photocatalytic reactor by agitating, moving and/or lifting the photocatalyst particles in a non-continuous sequential path around or across the stator surface which may improve the diffusion of reactant molecules to and from an active site of the catalyst and which may increase mass transfer

Throughout the specification, unless the context demands otherwise, the terms ‘comprise’ or ‘include’, or variations such as ‘comprises’ or ‘comprising’, ‘includes’ or ‘including’ will be understood to imply the inclusion of a stated integer or group of integers, but not the exclusion of any other integer or group of integers. Furthermore, relative terms such as “up”, “down”, “top”, “bottom”, “upper”, “lower”, “upward”, “downward”, “horizontal”, “vertical” and the like are used herein to indicate directions and locations as they apply to the appended drawings and will not be construed as limiting the invention and features thereof to particular arrangements or orientations. Likewise, the term “inlet” shall be construed as being an opening which, dependent on the direction of fluid flow, may also serve as an “outlet”, and vice versa.

The foregoing description of the invention has been presented for the purposes of illustration and description and is not intended to be exhaustive or to limit the invention to the precise form disclosed. The described embodiments were chosen and described in order to best explain the principles of the invention and its practical application to thereby enable others skilled in the art to best utilise the invention in various embodiments and with various modifications as are suited to the particular use contemplated. Therefore, further modifications or improvements may be incorporated without departing from the scope of the invention as defined by the appended claims.

1. A photocatalytic reactor stator, the stator comprising:
a first surface and an opposing second surface, and at least one channel extending between the first surface and the second surface to allow fluid flow through the stator, wherein the at least one channel has a profile shaped to redirect the fluid flow in a direction substantially parallel to the first and/or second surface.

2. (canceled)

3. The stator as claimed in claim 1 wherein the at least one channel has at least a partially curved shaped profile, an inverted L-shaped profile, an inverted J-shaped profile, or an S-shaped profile.

4-5. (canceled)

6. The stator as claimed in claim 1 wherein the stator comprises a plurality of channels wherein an area between one channel and a neighbouring channel defines a section or sector of the stator surface and wherein the redirected fluid flow is configured to move, lift and/or roll fluidised photocatalyst particles from one section or sector to a neighbouring section or sector in a sequential manner.

7-9. (canceled)

10. The stator as claimed in claim 52 wherein the hood is located at or around a channel outlet and extends from the first or second surface.

11. (canceled)

12. The stator as claimed in claim 1 wherein the first and/or second surfaces comprise a plurality of hood structures and the area between one hood and a neighbouring hood defines a section or sector of the stator surface.

13. The stator as claimed in claim 12 wherein an outer surface of the hood is configured to be substantially streamlined whereby fluidised photocatalyst particles flow across the outer surface of the hood and into the neighbouring section or sector.

14. The stator as claimed in claim 13 wherein the hood is configured to move, lift and/or roll the photocatalyst particles as the fluidised photocatalyst particles flow across the outer surface of the hood.

15. The stator as claimed in claim 1 wherein the at least one channel has an inlet on the first surface and an outlet on the second surface, and wherein the channel inlet forms a groove or slot on or across the first surface and the channel outlet forms a groove or slot on or across the second surface.

16-18. (canceled)

19. The stator as claimed in claim 1, wherein the at least one channel has an inlet on the first surface and an outlet on the second surface, and wherein the channel outlet has a cross-sectional area which is equal to or less than the cross-sectional area of the channel inlet.

20. The stator as claimed in claim 1, comprising a plurality of channels, wherein the plurality of channel outlets are arranged to induce non-continuous sequential movement of photocatalyst particles.

21-25. (canceled)

26. The stator as claimed in claim 1 wherein the stator comprises a substantially circular disc.

27. The stator as claimed in claim 1 wherein the at least one channel is configured to introduce a circular, rotational or helical flow component to the fluid.

28. The stator as claimed in claim 1 wherein the stator is configured to create a vortex in the fluid flow.

29. The stator as claimed in claim 1 wherein the stator comprises a minimum of two channels and a maximum of one hundred channels, and preferably twenty channels.

30. (canceled)

31. A photocatalytic reactor comprising:
a reaction chamber having a fluid inlet and a fluid outlet displaced in a longitudinal direction of the reaction chamber,
at least one stator, comprising a first surface and an opposing second surface, and at least one channel extending between the first surface and the second surface to allow fluid flow through the stator, wherein the at least one channel has a profile shaped to redirect the fluid flow in a direction substantially parallel to the first and/or second surface, located between the fluid inlet and the fluid outlet, and
a plurality of mobile photocatalyst particles disposed on the at least one stator.

32-41. (canceled)

42. The photocatalytic reactor as claimed in claim 31 wherein the reaction chamber comprises a plurality of spatially separated cells or sub-chambers, and wherein each cell or sub-chamber comprises a stator comprising a first surface and an opposing second surface, and at least one channel extending between the first surface and the second surface to allow fluid flow through the stator, wherein the at least one channel has a profile shaped to redirect the fluid flow in a direction substantially parallel to the first and/or second surface.

43. (canceled)

44. A method of carrying out a photocatalytic reaction, the method comprising:
providing a photocatalytic reactor comprising at least one stator according to claim 1;
providing a layer of mobile photocatalyst particles disposed on at least one surface of the stator;
providing a flow of fluid through the stator;
whereby the fluid flow is redirected in a direction substantially parallel to the at least one surface of the stator.

45-47. (canceled)

48. The method as claimed in claim 44, wherein redirecting the fluid flow sequentially moves the mobile photocatalyst particles around the at least one surface of the stator in a non-continuous path.

49-50. (canceled)

51. The stator as claimed in claim 1, wherein the at least one channel is configured to redirect the fluid flow in a direction substantially parallel to the first and/or second surface to lift and/or roll the photocatalyst particles across the first and/or second surface of the stator.

52. The stator as claimed in claim 1, comprising a hood associated with the at least one channel which redirects the fluid flow and prevents photocatalyst particles entering the at least one channel.
